(19) United States
(12) Patent Application Publication
(10) Pub. No.: US 2026/0012405 A1
(43) Pub. Date: Jan. 8, 2026

(54) SYSTEM AND METHOD TO ANALYZE AND VISUALIZE DRIVE TEST DATA

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Sundaresh SANKARAN, Mumbai, Maharashtra (IN); Haresh B AMBALIYA, Gujarat (IN); Makarand Sushil DERE, Panvel, Maharashtra (IN); Abhinav RANA, Dehradun, Uttrakhand (IN); Vikas WADHWANI, Madhya Pradesh (IN); Brijesh SHAH, Navi Mumbai, Maharashtra (IN); Nitesh Kumar CHOURASIA, Thane, Maharashtra (IN); Mayank TARAN, Thane, Maharashtra (IN); Vikram SINGH, Navi Mumbai, Maharashtra (IN)

(73) Assignee: JIO PLATFORMS LIMITED, Ahmedabad, Gujarat (IN)

(21) Appl. No.: 18/992,850

(22) PCT Filed: May 31, 2024
(86) PCT No.: PCT/IN2024/050662

§ 371 Date: Jan. 9, 2025

(30) Foreign Application Priority Data
Jun. 29, 2023 (IN) 202321043823

(51) Int. Cl. H04L 43/045; H04L 41/5009

(52) U.S. Cl. CPC H04L 43/045; H04L 41/5009

(57) ABSTRACT

The present invention discloses a system (108) and method for analyzing and visualizing data in context of a telecom network The system (108) allows drive test data from various sources to be efficiently parsed, translated, and validated 5 using a data parser module (212), a translator module (216), and a validator module (214) for each individual drive test data source. The processed data from each drive test data source is subsequently stored in a centralized database (210). The system enables the execution of separate processing jobs aimed at visualizing drive test data from multiple sources across different layers. The visualization aspect provides 10 valuable insights into the performance and characteristics of the telecom network, facilitating enhanced analysis and decision-making processes.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to the field of telecommunications. More particularly, the present disclosure relates to a system and a method for analysing and visualising the drive test data for a telecom network.

### DEFINITION

As used in the present disclosure, the following terms are generally intended to have the meaning as set forth below, except to the extent that the context in which they are used to indicate otherwise.

The expression ‘key performance indicator (KPI)’ used hereinafter in the specification refers to a measurable value that helps an organization to track and evaluate its progress toward achieving specific goals.

The expression ‘drive test data’ used hereinafter in the specification refers to data collected during mobile network drive tests. Drive tests involve physically driving or moving around an area while collecting data on various parameters of the mobile network, such as signal strength, call quality, data throughput, and handover performance between different cells or towers. This data is crucial for mobile network operators to optimize their network performance, identify areas with poor coverage or quality, and make necessary improvements. It helps them understand real-world user experience and optimize their network infrastructure accordingly. The drive test data usually includes information such as signal strength, signal quality, call drops, data throughput, and handover performance.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

In the telecommunications sector, drive tests are indispensable for collecting crucial data necessary for improving network functionality. For example, when deploying new infrastructure like cell towers or adjusting network configurations, engineers conduct drive tests to assess the impact on signal strength and overall network performance. These tests involve collecting data from various sources, such as mobile devices, to evaluate network performance indicators like coverage, quality, and interference. Analyzing and visualizing drive test data from multiple sources is essential for engineers to optimize telecom networks effectively.

Existing methods for visualizing drive test data from multiple sources require significant development efforts. Each time a new drive test data source was added to the visualization layer, extensive work was needed to parse, translate, validate, and process the data. This involved developing custom data parsing and translation algorithms for each data source, ensuring data consistency and accuracy, and integrating the data into the visualization system. The complexity of these tasks often resulted in time-consuming and resource-intensive development processes. Testing professionals had to invest substantial effort in understanding the data formats, parsing the data, addressing variations in naming conventions and data structures among different drive test tools, and validating the data to ensure its reliability.

Furthermore, the integration of data from multiple sources into a unified visualization layer posed additional challenges. Synchronizing and aligning data from diverse sources required intricate data mapping and processing techniques, making the development process even more cumbersome.

As a consequence, the existing methods for visualization of drive test data from multiple sources suffered from inefficiencies and limitations. The development efforts required for each new data source addition hindered scalability and agility in incorporating data from different drive test tools. This hindered the timely availability of accurate and comprehensive visualizations for network optimization.

There is, therefore, a need in the art to provide a system and a method that can mitigate the problems associated with the prior arts. There is a need in the field to address the challenges associated with parsing, translating, and integrating data from diverse sources into a unified visualization layer. A system and method are needed to streamline the development process and enhance the agility of the visualization system to accommodate data from different drive test tools seamlessly.

### OBJECTS OF THE INVENTION

It is an object of the present disclosure to provide a system and a method that minimizes development efforts required to incorporate new drive test data sources into the visualization layer, and by employing separate data parser, translator, and validator modules for each data source, the system eliminates the need for extensive custom development work every time a new data source is added.

It is an object of the present disclosure to provide a system and a method that allows for seamless scalability by efficiently handling new drive test data sources, with the common database storing validated drive test data from each source, the addition of a new source only requires the implementation of the corresponding data parser, translator, and validator entities.

It is an object of the present disclosure to provide a system and a method that empowers engineers to focus on the data that is most relevant to their analysis, enhancing efficiency and decision-making capabilities.

It is an object of the present disclosure to provide a system and a method that is capable for promptly identifying and addressing network issues and optimizing network performance KPIs, and engineers can gain up-to-date insights and take proactive measures to enhance coverage, quality, and interference management.

It is an object of the present disclosure to provide a system and a method that simplifies data analysis and comparison across different data sources, and engineers can easily identify variations, patterns, and trends, facilitating more accurate assessments and targeted optimization strategies.

### SUMMARY

The present disclosure discloses a method for visualizing a drive test data received from a plurality of data sources. The method includes receiving, by one or more processors, a plurality of drive test data from the plurality of data sources. Each source includes a plurality of key performance indicators (KPIs) information. The method includes parsing the received plurality of drive test data by one or more dedicated data parser modules to extract KPI information corresponding to each KPI and generating a parsed drive test data. The method includes translating, by one or more dedicated translator modules, the parsed drive test data for generating a translated drive test data having a uniform format. The method includes validating, by one or more dedicated validator modules, the translated drive test data based on a plurality of attributes to generate a validated drive test data. The method includes storing, in a centralized database, the validated drive test data. The method includes visualizing, by a user interface module, the stored drive test data.

In an embodiment, the method further includes a step of enabling an end-user to select and visualize the drive test data corresponding to each data source by providing a dropdown wizard list, including details of the plurality of data sources.

In an embodiment, the method further includes a step of generating a plurality of reports by employing at least one optimization decision technique by leveraging the plurality of KPIs from the plurality of data sources.

In an embodiment, the method further includes a step of displaying a layering data combined from different data sources, allowing the end-user to select a view of drive test data by combining two or more data sources.

In an embodiment, the plurality of attributes includes an accuracy attribute, a consistency attribute, a range attribute, and a completeness attribute.

In an embodiment, the method further includes a step of storing the validated drive test data, in the centralized database (310), along with a network performance Key Performance Indicator (KPI) and a unique data source identifier.

In an embodiment, the plurality of KPIs includes a reference signal received power (RSRP), a signal to noise interference ratio (SINR), a reference signal received quality (RSRQ), an uplink throughput, and a downlink throughput.

In an embodiment, the method further includes a step of updating the centralized database when a new data source is incorporated, ensuring seamless access and visualization of updated drive test data.

The present disclosure discloses a system for analyzing and visualizing drive test data received from a plurality of data sources. The system includes one or more processors, one or more dedicated data parser modules, one or more dedicated translator modules, one or more dedicated validator modules, a centralized database, and a user interface module. The one or more processors are configured to receive a plurality of drive test data from the plurality of data sources. Each source is configured to have a plurality of key performance indicators (KPIs). The one or more dedicated data parser modules for each individual data source are configured to parse the received drive test data to extract KPI information corresponding to each KPI for generating a parsed drive test data. The one or more dedicated translator modules for each data source, are configured to translate the parsed drive test data to generate a translated drive test data having a uniform format. The one or more dedicated validator modules for each data source, are configured to validate the translated drive test data based on a plurality of attributes to generate a validated drive test data. The centralized database is configured to store the validated drive test data. The user interface module is configured to visualize the stored drive test data.

In an embodiment, the user interface module is configured to enable an end-user to select and visualize drive test data corresponding to each data source by providing a dropdown wizard list including details of the plurality of data sources.

In an embodiment, the user interface module is configured to display a layering data combined from different data sources, allowing the end-user to select a view of drive test data by combining two or more data sources.

In an embodiment, the plurality of attributes includes an accuracy attribute, a consistency attribute, a range attribute, and a completeness attribute.

In an embodiment, the centralized database is configured to store the validated drive test data along with a network performance Key Performance Indicator (KPI) and a unique data source identifier.

In an embodiment, the plurality of KPIs includes a reference signal received power (RSRP), a signal to noise interference ratio (SINR), a reference signal received quality (RSRQ), an uplink throughput, and a downlink throughput.

In an embodiment, the system further configured to generate a plurality of reports by employing at least one optimization decision technique by leveraging the plurality of KPIs from the plurality of data sources.

In an embodiment, the system configured to update the centralized database, when a new data source is incorporated, ensuring seamless access and visualization of the updated drive test data.

The present disclosure discloses a user equipment configured to analyze and visualize drive test data. The user equipment includes a processor, and a computer readable storage medium storing programming instructions for execution by the processor. The programming instructions to receive a plurality of drive test data from a plurality of data sources, each source is configured to have a plurality of key performance indicators (KPIs) information. The processor is configured to parse the received drive test data to extract KPI information corresponding to each KPI to generate a parsed drive test data. The processor is configured to translate the parsed drive test data to generate a translated drive test data having a uniform format. The processor is configured to validate the translated drive test data based on a plurality of attributes to generate a validated drive test data. The processor is configured to store the validated drive test data. The processor is configured to visualize the stored drive test data.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture for implementing a system for analyzing and visualizing drive test data received from a plurality of data sources, in accordance with an embodiment of the present disclosure.

FIG. 2 illustrates an example block diagram of the system, in accordance with an embodiment of the present disclosure.

FIG. 3 illustrates an exemplary flowchart for analysing and visualising telecom network data, in accordance with an embodiment of the present disclosure.

FIGS. 4A-4G illustrate exemplary representations of an interface to visualize drive test data, in accordance with some embodiments of the present disclosure.

FIG. 5 illustrates an example computer system in which or with which the embodiments of the present disclosure may be implemented.

FIG. 6 illustrates an exemplary method of analyzing and visualizing drive test data received from a plurality of data sources, in accordance with an embodiment of the present disclosure.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—User Equipments (UEs)
106—Network
108—System
202—Processor(s)
204—Memory
206—Interface(s)
210, 310—Database
212, 304A-304C—Data Parser Module
214, 306A-306C—Data Validator Module
216, 308A-308C—Data Translator Module
218, 311—User Interface Module
312—Data Processor
500—Computer System
510—External Storage Device
520—Bus
530—Main Memory
540—Read Only Memory
550—Mass Storage Device
560—Communication Port
570—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology is also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

Network deployment is a critical process for any operator, and a drive test activity is an essential component of this process. It helps to ensure that the network is functioning optimally and meets the requirements of the operator. In order to achieve this, pre-network deployment and post-network deployment optimization are continuous processes that must be carried out until the network stabilizes. To analyze and optimize the network performance KPI, such as coverage, quality, and interference, engineers need to visualize drive test data from multiple sources over the layer. This helps them to pinpoint areas that require improvement and determine the best course of action to take. By analyzing the data, engineers can identify any areas that are not meeting the required performance standards and make the necessary adjustments to optimize network performance.

The existing methods for visualizing drive test data from multiple sources require significant development efforts to parse, translate, validate, and process the data for layer visualization. This can be time-consuming and challenging whenever a new drive test data source is added.

The present disclosure is configured to save validated drive test data from multiple sources into a common database with a data source identifier, then process and save the data in Hbase (database management system) on the backend. On the front end, a user interface with a dropdown option containing all available data sources will be provided to end-users for layer visualization. Users can choose whether to visualize combined data from all sources or data from a specific source.

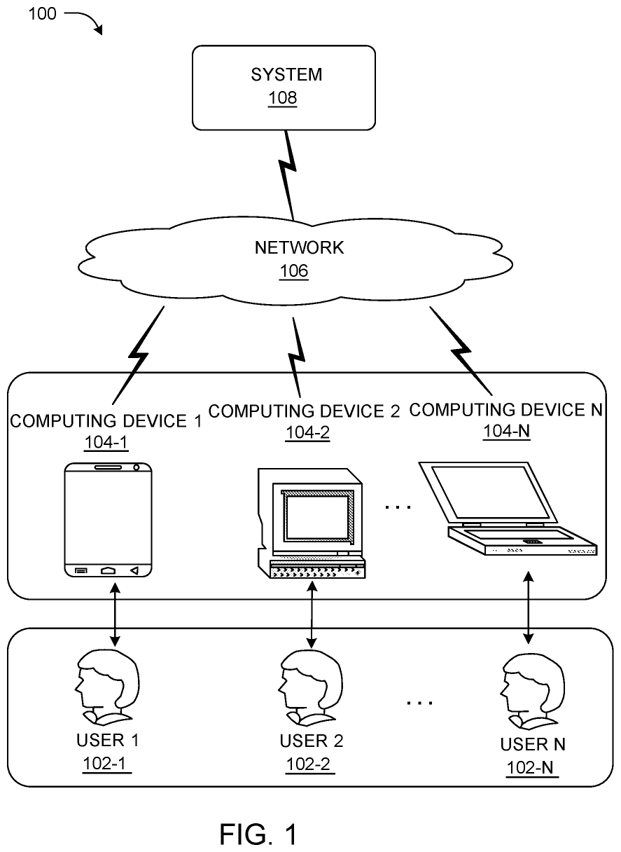

The various embodiments throughout the disclosure will be explained in more detail with reference to FIG. 1-FIG. 6.

FIG. 1 illustrates an example network architecture (100) for implementing a system (108) for analyzing and visualizing drive test data received from a plurality of data sources, in accordance with an embodiment of the present disclosure.

As illustrated in FIG. 1, one or more computing devices (104-1, 104-2 . . . 104-N) may be connected to the system (108) for analyzing and visualizing data for a telecom network through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may be configured to receive an input (drive test data or information) from a plurality of data sources. In an example, the plurality of data sources includes a domain name system server, an active directory server, a service configuration server, or a web application. In an example, the system is configured to interact with the end users through the computing devices 104. The system performs parsing and translates the drive test data. The system (108) is configured to validate the parsed drive test data. In an embodiment, the system (108) is configured to store the validated drive test data from each data source, and each data entry in a database is associated with a data source identifier. In another embodiment, the system (108) is configured to process the validated drive test data and store the processed data in a database, a distributed database (Hbase) or any other database).

In an operative aspect, the system (108) is configured to provide visualization options including dropdown options, visualization buttons, slider control, radio buttons, toggle switches, etc., containing all available data sources associated with the system and enable end users to select and visualize drive test data on a layer.

In an embodiment, the system (108) is configured to visualize the latest drive test data and further allow the end users to visualize the combined drive test data from all data sources or the drive test data from a specific data source separately on the associated computing device (104).

In an exemplary implementation, the system (108) is configured to visualize drive test data from various sources while minimizing the development efforts required for incorporating new data sources. This is achieved by saving the data from each individual drive test data source in a common database, which includes key performance indicators (KPIs) to be visualized on a layer, such as Coverage (RSRP), Throughput (DL/UL), and Interference signal to noise ratio (SINR). The RSRP is a parameter used in wireless communication systems to measure the quality of a received signal. The RSRP represents the power of a reference signal received by a receiver (UE), normalized to the power of a transmitted signal. A higher RSRP indicates a stronger signal, while a lower RSRP indicates a weaker signal. The RSRP is commonly used to evaluate the quality of a received signal and estimate the amount of data that can be transmitted without errors. The UE usually measures RSRP or RSRQ based on the direction (RRC message) from the network and reports the value. The RSSI indicates the strength of the signal received by the UE. The SINR measures signal quality by comparing the strength of a required signal to the unnecessary interference and noise. Mobile network operators seek to maximize SINR at all sites to deliver the best possible customer experience, either by transmitting at a higher power or by minimizing interference and noise.

Additionally, different drive test tools may have different naming conventions for similar entities. For instance, a first conventional tool may refer to the Coverage key performance indicators (KPIs) as Reference-Signal-Receive-Power (RSRP), Throughput, while a second conventional may use a different naming convention like Rx lev for RSRP. Similarly, network KPI parameters may vary in naming conventions across different drive test tools. To address these variations, the system employs separate data parser, translator, and validator modules for each individual data source. These modules ensure that the data is properly parsed, translated, and validated before being stored in the common database. The common database includes a single column for network performance KPIs like RSRP, SINR, and Throughput, along with an additional column that identifies the specific drive test data source. The processed data is then saved in a database management system. In an example, the database management system is Hbase. The Hbase is configured to store the data with a date-wise partition. In an example, the HBase is a column-oriented non-relational database management system. In an aspect, the HBase may be configured to operate with a Hadoop Distributed File System (HDFS). HDFS is a distributed file system that handles large data sets running on commodity hardware. In an aspect, a plurality of hive tables may be created on HDFS partitioned data for further use cases and reporting.

Individual jobs can be executed to visualize each drive test data from different sources on the layer. In future, if a new data source is introduced, the development team does not need to start from scratch. Only separate data parser, translator, and validator entities need to be created. Once the data from the new source is added to the common database with a new data source identifier, the drive test data from the new source is readily available for visualization on the layer, minimizing development efforts. On the front end, only the name of the new data source needs to be added to the data source dropdown list.

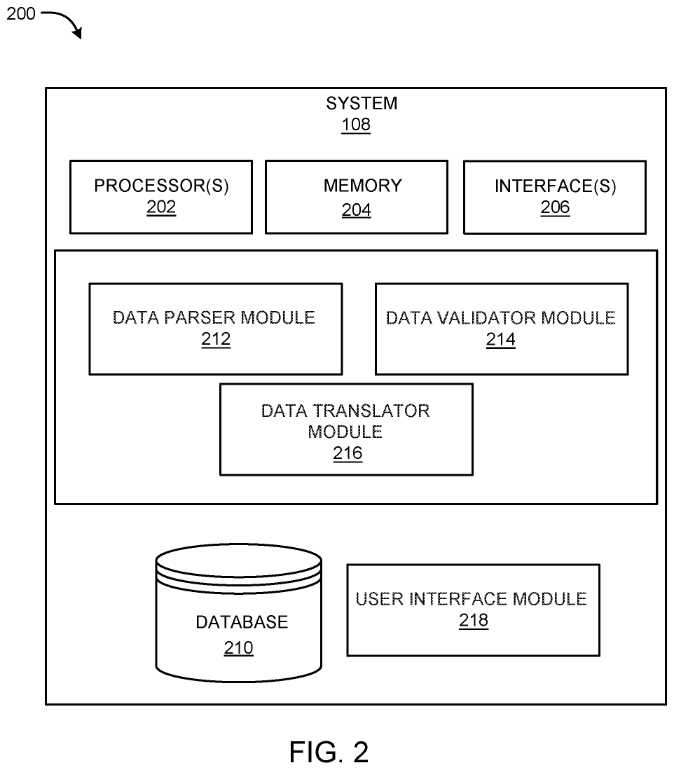

FIG. 2 illustrates an example block diagram (200) of the system (108), in accordance with an embodiment of the present disclosure. The system (108) is capable of processing and visualizing telecommunications drive test data from multiple sources.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206) enabling data exchanges between various components of the system and external devices. These interfaces (206) may include, but are not limited to, interfaces for data input/output devices and storage devices. The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, a user interface module (218) and a database (210). Further, the system further includes a data parser module (212), a data validator module (214), a data translator module (216) and other engine(s). In an embodiment, the other engine(s) may include, but not limited to, a data ingestion engine, an input/output engine, and a notification engine.

In an embodiment, the one or more processor(s) (202) of the system (108) may be implemented as a combination of hardware and programming (for example, programmable instructions) to implement one or more functionalities of the one or more processor(s) (202). In examples described herein, such combinations of hardware and programming may be implemented in several different ways. For example, the programming for the one or more processor(s) (202) may be processor-executable instructions stored on a non-transitory machine-readable storage medium and the hardware for the one or more processor(s) (202) may comprise a processing resource (for example, one or more processors), to execute such instructions. In the present examples, the machine-readable storage medium may store instructions that, when executed by the processing resource, implement the one or more processor(s) (202). In such examples, the system may comprise the machine-readable storage medium storing the instructions and the processing resource to execute the instructions, or the machine-readable storage medium may be separate but accessible to the system and the processing resource. In other examples, the one or more processor(s) (202) may be implemented by electronic circuitry.

The user equipment is configured to initiate a data visualization request. In an example, a user may be configured to initiate the data visualization request via a mobile application installed in the user equipment. In some examples, the mobile application may be a software or a mobile application from an application distribution platform. Examples of application distribution platforms include the App Store for iOS provided by Apple, Inc., Play Store for Android OS provided by Google Inc., and such application distribution platforms. For example, the mobile application may have access to a number of parameters associated with the user equipment, such as the current location of the user equipment and files stored within the user equipment. In an example, the speed measurement request may include details of a specific data source.

A memory of the user equipment is configured to store program instructions. The memory is configured to store the data received from the mobile application. The program instructions include a program that implements a method to initiate the data analysis and visualization in accordance with embodiments of the present disclosure and may implement other embodiments described in this specification. The memory may be configured to store pre-processed data. The memory may include any computer-readable medium known in the art including, for example, volatile memory, such as Static Random Access Memory (SRAM) and Dynamic Random Access Memory (DRAM) and/or non-volatile memory, such as Read Only Memory (ROM), erasable programmable ROM, flash memories, hard disks, optical disks, and magnetic tapes.

In an aspect, the mobile application may be configured to, via a processing unit, fetch and execute computer-readable instructions stored in the memory of the UE. The processing unit may be configured to execute a sequence of instructions of the method to initiate the data visualization, which may be embodied in a program or software. The instructions can be directed to the processing unit, which may subsequently program or otherwise be configured to implement the methods of the present disclosure. In some examples, the processing unit is configured to control and/or communicate with large databases, perform high-volume transaction processing, and generate reports from large databases. The processing unit may be implemented as one or more microprocessors, microcomputers, microcontrollers, digital signal processors, central processing units, state machines, logic circuitries, and/or any devices that manipulate signals based on operational instructions.

The one or more processor(s) (202) are configured to receive drive test data from the plurality of data sources. Each data source is configured to have a plurality of key performance indicators (KPIs). In an example, the plurality of KPIs includes a reference signal received power (RSRP), a signal to noise interference ratio (SINR), a reference signal received quality (RSRQ), an uplink throughput, and a downlink throughput. The one or more dedicated data parser modules for each individual data source is configured to parse the received drive test data to extract KPI information corresponding to each KPI for generating a parsed drive test data. The one or more dedicated translator modules for each data source, is configured to translate the parsed drive test data to generate a translated drive test data having a uniform format. The one or more dedicated validator modules for each data source, is configured to validate the translated drive test data based on a plurality of attributes to generate a validated drive test data. In an example, the plurality of attributes includes an accuracy attribute, a consistency attribute, and a completeness attribute.

The data parser module (212) and the data translator module (216) are two integral components of the system that processes drive test data. The process of parsing and translating drive test data involves extracting relevant information from the data and converting it into a format that can be easily understood and processed by the system. This is a critical step in enabling the system to effectively handle and utilize the drive test data for further analysis and visualization.

The data parser module (212) is responsible for extracting relevant information from raw drive test data. For example, the information may include data such as signal strength, call quality, and network performance indicators. Once this information is extracted, the data translator module (216) takes over and converts the data into a format that can be easily understood and processed by the system. This format typically involves converting the data into a standard file format such as CSV, JSON, or XML.

By performing these parsing and translation operations, the system effectively handles and utilizes the drive test data. The drive test data is analyzed and visualized to gain insights into network performance, identify areas for improvement, and make data-driven decisions.

The centralized database is configured to store the validated drive test data. In an embodiment, the centralized database is configured to store the validated drive test data along with a network performance Key Performance Indicator (KPI) and a unique data source identifier. The system is configured to update the centralized database when a new data source is incorporated, ensuring seamless access and visualization of the updated drive test data.

Further, the processing unit (208) includes a user interface module. The user interface module dynamically updates the displayed data, reflecting real-time changes and enabling users to monitor the most up-to-date network performance information that is configured to visualize the stored drive test data. The user interface module (218) enables an end-user to select and visualize drive test data corresponding to each data source by providing visualization options such as a dropdown wizard list that includes details of the plurality of data sources. The user interface module (218) is configured to display layering data combined from different data sources, allowing the end-user to select a view of drive test data by combining two or more data sources. The layering data refers to a technique used in data visualization where multiple layers of information are combined to create a comprehensive view of a dataset. Each layer represents a different aspect or dimension of the data, allowing viewers to explore and analyze various relationships and patterns. In layered visualization, different types of visual elements such as charts, graphs, maps, or other graphical representations are overlaid on top of each other. Each layer may convey different types of data, such as numerical values, categories, spatial information, or temporal trends. By combining these layers, users can gain deeper insights into the data and uncover hidden patterns that may not be apparent when examining each layer individually. Layered visualization is particularly useful for complex datasets with multiple variables or dimensions, as it enables users to visualize and analyze relationships between different aspects of the data simultaneously. It can also facilitate interactive exploration, allowing users to dynamically adjust and manipulate the layers to focus on specific areas of interest or to reveal different perspectives on the data. In the current context, the data from individual data sources may be shown in a combined manner in a single layer or data from individual data sources may be shown in a separate layer.

The system is further configured to generate a plurality of reports by employing at least one optimization decision technique by leveraging the plurality of KPIs from the plurality of data sources.

In an embodiment, the system is configured to validate the parsed drive test data from the respective data parser module (212) by the data validator module (214). After the data has been parsed and translated by the respective data parser module (212), the data translator module (216) verifies its accuracy, consistency, and adherence to predefined criteria or standards. The validation process ensures that the drive test data is reliable and suitable for further analysis. Once the drive test data has been validated, the system (108) stores it in the centralized database. Each entry in the centralized database is associated with the data source identifier, which indicates the specific source from which the data originated. This association allows for easy identification and retrieval of data from different sources when needed.

Moreover, by storing the validated drive test data in the centralized database with the data source identifiers, the system establishes a structured and organized repository of reliable data. This facilitates efficient data management, enables easy access and retrieval, and promotes consistent analysis and visualization of drive test data from multiple sources.

In an aspect, the system includes a backend processing module that may apply algorithms, statistical analyses, or other computational techniques to analyze the drive test data. This can include aggregating data, calculating key performance indicators (KPIs) like Reference-Signal-Receive-Power (RSRP), signal-to-noise ratio (SINR), Throughput, identifying trends or patterns, and performing any necessary data transformations or computations. When the processing is complete, the system stores the processed data in Hbase, which may be a distributed and scalable NoSQL database. NoSQL are non-tabular databases and store data differently than relational tables. Storing the processed data in Hbase allows for efficient storage, retrieval, and querying of large volumes of data. Hbase provides the necessary infrastructure to handle the substantial amount of drive test data generated by multiple sources.

Moreover, by processing and storing the validated drive test data in Hbase, the system enables efficient data management, facilitates advanced analytics, and supports real-time visualization and querying of network performance data. This allows engineers and analysts to gain valuable insights, make informed decisions, and optimize telecom network performance based on the processed data stored in Hbase.

Additionally, the system offers flexibility to end users in terms of data visualization. Users have the option to either visualize the combined drive test data from all available data sources or focus on the drive test data from a specific data source. By selecting their preferred option, users can tailor their analysis to suit their specific needs and requirements. This capability empowers end users to have greater control and customization over the visualization of drive test data. They can choose to examine the collective performance of all data sources or concentrate on specific sources to gain detailed insights. This flexibility facilitates more accurate analysis, targeted optimization efforts, and better decision-making in optimizing telecom network performance.

The system reduces backend development efforts as it is able to handle any new source with minimal work on translating the data, and it enhances user experience as the end user can either visualize combined data or data from individual data sources overlay.

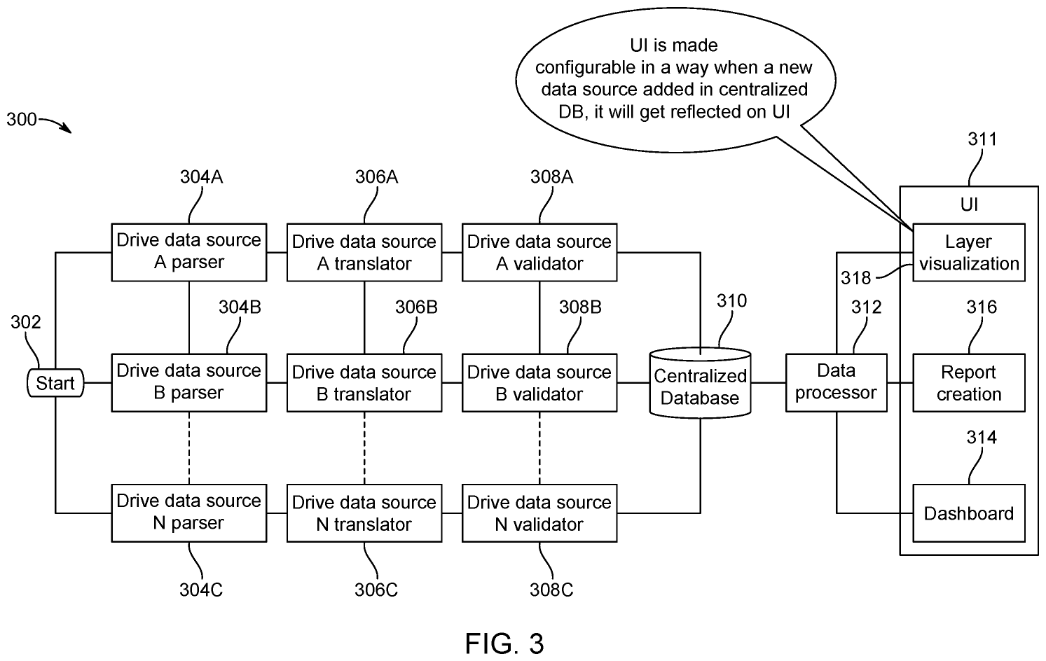

FIG. 3 illustrates an exemplary flowchart (300) for analysing and visualising telecom network data, in accordance with an embodiment of the present disclosure.

The system includes one or more processors, one or more dedicated data parser modules (304A-304C), one or more dedicated translator modules (306A-306C), one or more dedicated validator modules (308A-308C), a centralized database (310), and a user interface module (311).

As depicted in FIG. 3, a flowchart (300) is presented to illustrate process of analyzing and visualizing crowd-sourced data for a telecom network, in accordance with one embodiment. The flowchart demonstrates the sequential steps involved in the system, which initiates at step (302). At step 302, one or more processors are configured to receive drive test data from the plurality of data sources. Each source is configured to have a plurality of key performance indicators (KPIs) information.

At step (304), the parsing process is performed on the drive test data. The one or more dedicated data parser modules (304A-304C) for each individual data source, is configured to parse the received drive test data to extract KPI information corresponding to each KPI of each of the plurality of data sources. The drive data is collected from various sources, such as source A, source B, and source N. To parse the data collected from each source, a dedicated data parser is implemented. Data parser (304A) is a dedicated data parser for the source A, a data parser (304B) is a dedicated data parser for the source B, a data parser (304C) is a dedicated data parser for the source N. Each data parser is configured to parse the received drive test data to extract relevant KPI information from the respective data source. Parsing involves extracting and organizing the relevant information from each drive data source.

In an implementation, a dedicated translator module is implemented for each data source. The one or more dedicated translator modules (306A-306C) is configured to translate the parsed drive test data to generate a translated drive test. The translator module is configured to translate the parsed data into a standardized format to ensure uniformity of data representation. In one example, the translator module (306A) is configured to translate the parsed data from source A, the translator module (306B) is configured to translate the parsed data from source B, and the translator module (306C) is configured to translate the parsed data from source N. The translation process ensures that the data is converted into a standardized format that can be easily understood and processed by the system.

After the translation step, a dedicated validator module for each data source is configured to validate the translated data for accuracy, consistency, and completeness. The one or more dedicated validator modules (308A-308C) are configured to validate the translated drive test data based on a plurality of attributes to generate a validated drive test data. In an example, the one or more dedicated validator modules (308A-308C) are configured to validate the translated drive test data by mapping the drive test data with a range associated with each of the KPI. In an example, the memory is configured to store a predefined range corresponding to each of the KPI. In an example, the plurality of attributes includes an accuracy attribute, a consistency attribute, a range attribute, and a completeness attribute. The range attribute refers to an input element that allows users to select a value within a specified range. In an example, the range attribute is often presented as a slider, where the users can drag a handle along a track to choose a value within the defined range.

The validator module (308A) validates the drive data from source A, the validator module (308B) validates the drive data from source B, and the validator module (308C) validates the drive data from source N. The validation process ensures the accuracy, consistency, and reliability of the data by checking for errors, inconsistencies, or missing values.

The validated drive data then is stored in a centralized database (DB) (310) for efficient storage and retrieval. The stored data undergoes processing to derive meaningful insights and perform necessary calculations. Additionally, the system (108) enables layer visualization (318) and report generation (316) based on the processed data. The visualizations and reports are then displayed on a dashboard (314) that features a user interface (UI) (311). In an aspect, the user interface module (311) includes a dropdown wizard list including available data sources, thereby enabling an end-user to select and visualize the drive test data received from newly added data sources. In an embodiment, the user interface module (311) is configured to display layering data from different data sources and allow the end-user to select a view of drive test data by combining two or more data sources or an individual data source.

In an embodiment, the UI (311) is designed to provide a user-friendly experience and allows users to interact with the system. It provides various functionalities for data exploration, analysis, and customization. In an embodiment, the system is further configured to update the centralized database (310), when a new data source is incorporated, ensuring seamless access and visualization of the updated drive test data. The UI (311) is configurable to accommodate changes in the centralized database (310), especially when a new data source is added. When a new data source is incorporated into the centralized database, the UI (311) is updated to reflect this change. This ensures that the newly added data source becomes accessible and visible within the UI (311). Users can seamlessly navigate and select the desired data sources for visualization, analysis, and reporting purposes.

The centralized database (310) is configured to store the validated drive test data. The centralized database (310) is configured store the validated drive test data along with a network performance Key Performance Indicator (KPI) and a unique data source identifier. The validated drive test data along with the network performance KPIs stored in the centralized database (310) are processed by a data processor (312) for visualization.

Moreover, the configurable nature of the UI (311) ensures that the system remains adaptable and can accommodate future enhancements and additions of data sources. The UI (311) provides a flexible and dynamic interface that empowers users to effectively explore and leverage the available drive test data from multiple sources for their analysis and decision-making needs.

In an aspect, the system is further configured to generate a plurality of reports by employing at least one optimization decision technique by leveraging visualized KPIs and interference from the plurality of data sources. In examples, optimization decision techniques involve techniques for making decisions aimed at optimizing certain objectives or criteria, often in situations where there are multiple conflicting goals or constraints. In current context, data from multiple sources may be conflicting or interfering. The optimization decision techniques solve these conflicts, interferences, etc., using the visualized KPIs and the interference from the plurality of data sources. One or more optimization decision techniques may be used such as linear programming, dynamic programming, constraint programming, non-linear programming, genetic algorithms, simulated annealing, etc.

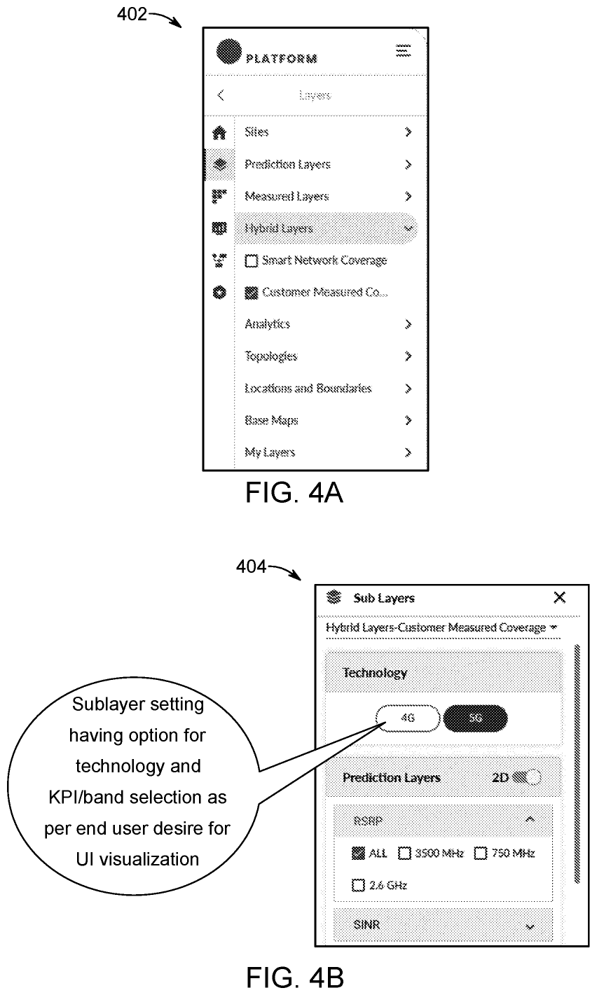

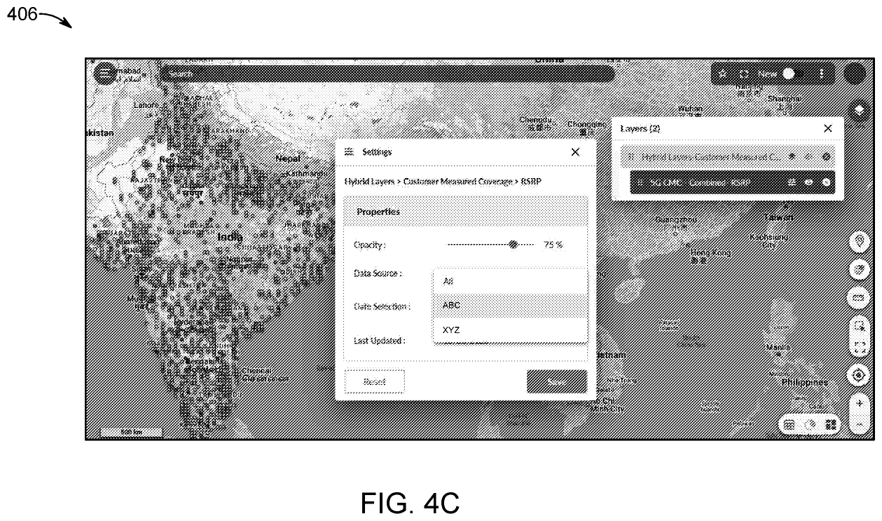

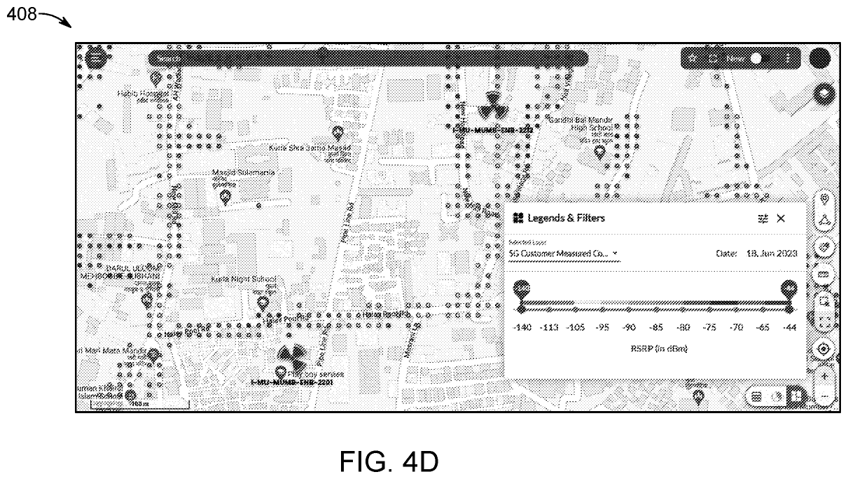

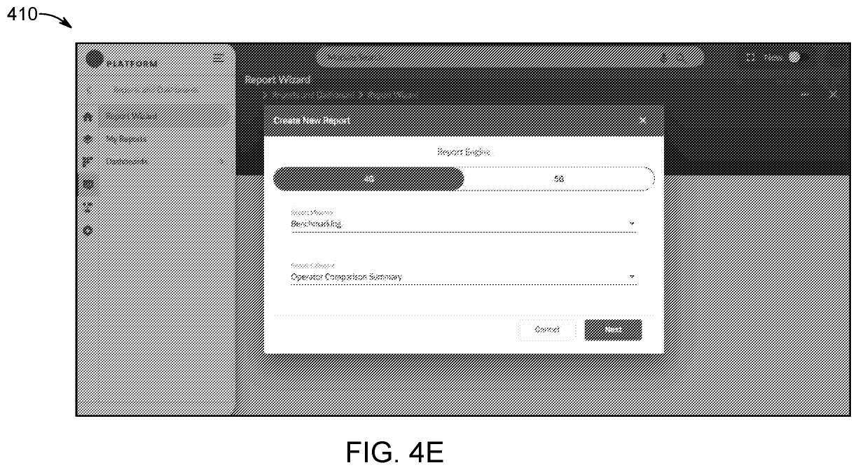

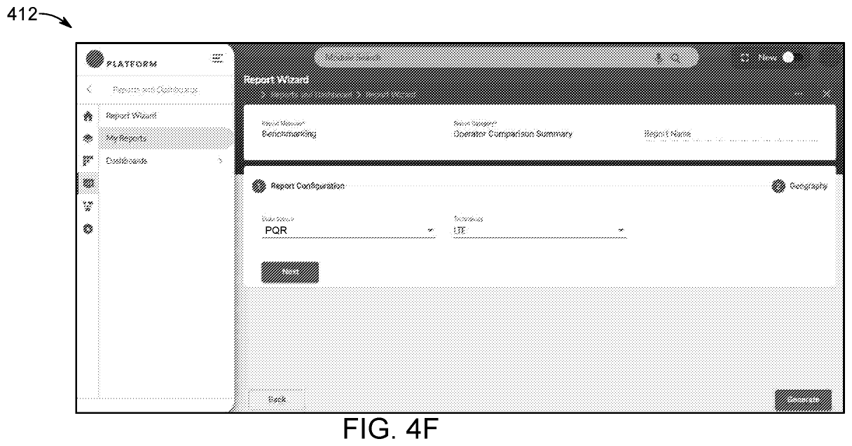

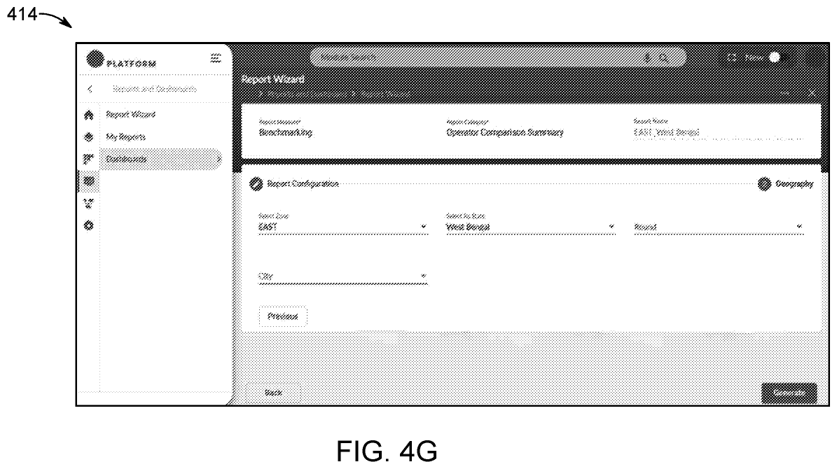

FIGS. 4A-4G illustrate exemplary representations of an interface (an interactive webpage of a visualization web application) to visualise drive data, in accordance with some embodiments of the present disclosure.

FIGS. 4A represents an interactive home page (402) of the visualization web application. As illustrated, the data visualization on layer navigation is depicted. Within a hybrid layer, the customer (user) is able to select a measured coverage layer, as shown in FIG. 4A. The UI (311) is configured to receive the selection (a request) from the user and is further configured to send the received request to the data processor (312). The data processor (312) processes the request (or pre-processed data for each visualization type) and receives the data from the centralized database (310). In an example, the request includes location coordinates, sublayer settings, data source selected (or combined), filter parameters, etc. The data processor (312) is configured to generate a visual output as a response and communicates the generated visual output to be displayed on the UI (311), showing the selected visuals.

FIG. 4B demonstrates a sublayer filter settings (404) of the visualization web application, where the users can open the sub-layer settings and choose the desired technology such as 4G, or 5G, a frequency (for example, 3500 MHz, 2.6 GHz), and key performance indicators (KPIs) such as RSRP, SINR, DL throughput, or UL throughput for a particular frequency for visualization according to their preferences.

In FIG. 4C, the data is displayed on the layer (406), and the users can open the respective sublayer settings and select the data source they wish to view. In an example, the data processor (312) is configured to receive the drive test data from the plurality of data sources, such as the XYZ data source and the ABC data source. These data sources consist of a range of servers, including a domain name system server, an active directory server, a service configuration server, or a web application. To select one or more data sources, the user may access a drop-down menu that lists all the data sources. It is possible for the user to select more than one data source, enabling them to view the merged data on the layer (406). To retrieve data from one or more data sources, the user may choose a specific date range. This embodiment allows the user to specify the exact time period for the data retrieval.

FIG. 4D shows an enlarged visualization (408) of the displayed data indicating the KPI range in the legends. For example, the user may be able to modify the range of key performance indicators (KPIs) to create more informative and clear visualizations. For example, for the RSRP KPI, the user may specify a range such as −140 to −95. This modification can provide a more precise and focused visual representation of the data to the user, enabling them to make more informed decisions based on the data presented. By adjusting the range of KPI values, users can tailor their visualization to their specific needs and preferences, enhancing the overall effectiveness of the data analysis.

The processed data is presented in a report format (410) in FIG. 4E. During the report generation (316), the system is configured to employ a report generation engine (report wizard) that is capable of generating customized reports based on the user's specific selection criteria. addition, the report generation engine is also configured to store the generated reports for future reference or analysis. Furthermore, the report generation engine is specifically designed to generate a benchmark report that includes key performance indicators (KPIs) for different vendors or operators. This benchmark report allows direct comparisons between different vendors or operators, which can help identify areas for improvement and inform decision-making processes. Overall, the report generation engine is an essential component of the system, providing valuable insights and data-driven analysis to support business operations and strategic planning.

FIG. 4F shows another display screen (412) that offers a useful option for configuring the report according to specific parameters. The parameters include selecting the data source (such as the PQR data source) and technology (for instance, 4G). Upon selecting these parameters, the report generation engine begins to compile the report based on the user's input. The engine generates a report that corresponds to the specific data source chosen (in this case, the PQR data source) and the particular technology selected (in this instance, 4G). By doing so, the report is tailored to the user's needs and preferences, with the result representing the desired output report accurately.

In FIG. 4G, users can choose from the display screen (414) to generate the benchmark report. The benchmark report includes an operator comparison summary based on geography. The system is configured to conduct a plurality of rounds to generate a plurality of drive test reports. The benchmark report streamlines the process by allowing the users to specify test parameters, upload collected data, select analysis options, and customize report formats. The user is able to select a drive round for downloading the report, allowing his/her to compare pre-network and post-network performance. The system (108) significantly reduces frontend development efforts in the UI as only the addition of a new data source is required in the data source dropdown wizard list. The report generation engine allows the users to select the specific drive round for which they want to generate the report. This feature is particularly useful when multiple drive tests are conducted at the same location. For instance, the user can select a specific drive round to compare a pre-drive result and a post-drive result of a specific location. It is worth noting that the drive rounds for the same city will be denoted in an incremental manner. This means that each drive round will have a unique number that will increase with subsequent round tests. For example, if a drive test is conducted in a specific city and the first round is denoted as “Round 1”, the next round will be denoted as “Round 2”, and so on. With this numbering system, users can easily identify and select the specific drive round they want to generate a report for.

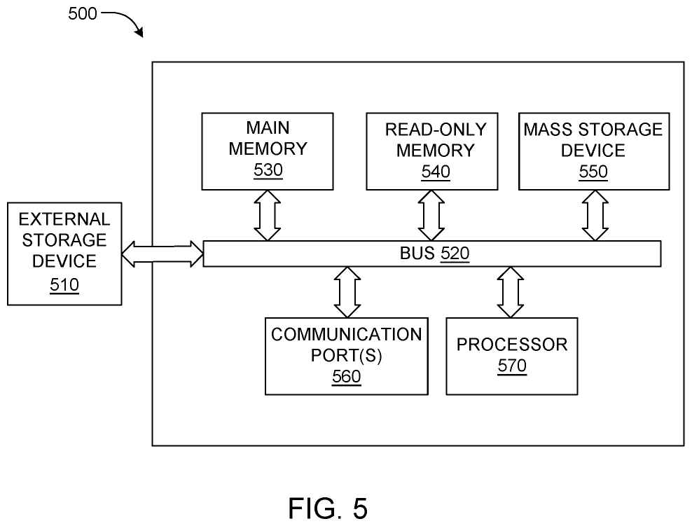

FIG. 5 illustrates an example computer system (500) in which or with which the embodiment of the present disclosure is implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (970) with the other memory, storage, and communication blocks. The bus (920) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (570) to the computer system (500).

In another embodiment, operator, and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

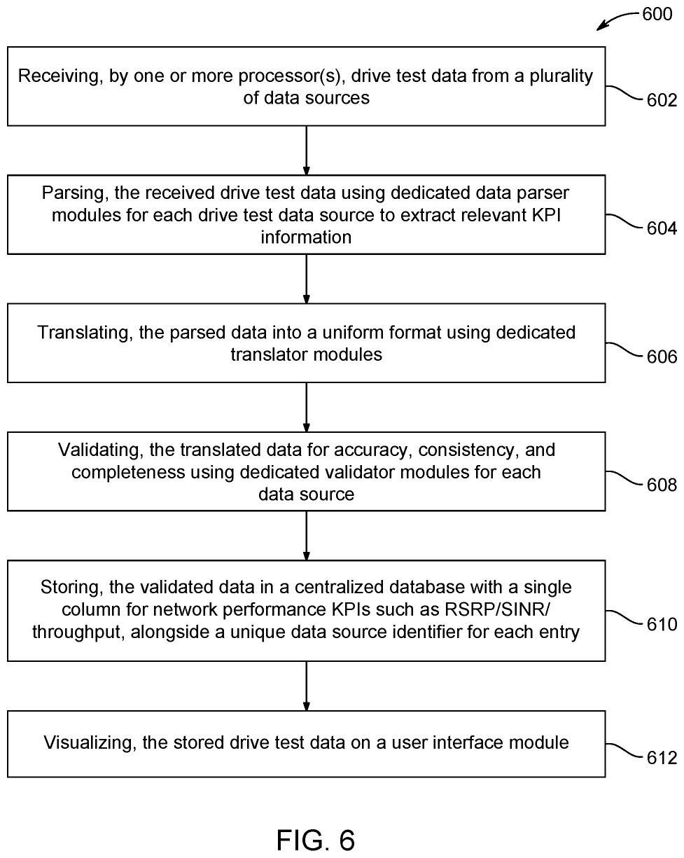

FIG. 6 illustrates a method (600) of analyzing and visualizing drive test data received from the plurality of data sources, in accordance with one embodiment.

At step (602), the drive test data is received from a plurality of data sources. Each data source includes its own naming conventions for key performance indicators (KPIs). In an example, the plurality of data sources includes a domain name system server, an active directory server, a service configuration server, or a web application.

At step (604), the received drive test data is parsed using the data parser modules dedicated for each individual drive test data source to extract relevant KPI information.

At step (606), the parsed data is translated by the one or more processor(s) into a standardized format using dedicated translator modules for each data source to ensure uniformity of data representation. The one or more dedicated translator modules (306A-306C) are configured to translate the parsed drive test data to generate translated drive test data.

At step (608), the translated data is validated by the one or more processor(s) for accuracy, consistency, and completeness using dedicated validator modules for each data source. The one or more dedicated validator modules (308A-308C) are configured to validate the translated drive test data based on a plurality of attributes to generate validated drive test data. In an example, the plurality of attributes includes an accuracy attribute, a consistency attribute, and a completeness attribute. The accuracy attribute refers to a correctness and precision of the data. In 5G networks, accurate data ensures that information about network performance, user behaviour, and environmental conditions is reliable and free from errors. For example, accurate location data from smartphones and IoT devices is essential for applications like navigation, asset tracking, and emergency response. The consistency attribute refers to a uniformity and coherence of data across different sources and over time. In 5G networks, consistent data ensures that information remains reliable and usable across various applications and services. For instance, consistent network performance metrics enable operators to make informed decisions about resource allocation and optimization strategies. The completeness attribute refers to an extent to which data contains all the necessary information required for its intended purpose. In 5G networks, complete data ensures that no essential details are missing, enabling accurate analysis and decision-making. For example, complete user profiles with demographic information and usage patterns enable personalized services and targeted marketing campaigns.

At step (610), the validated drive test data is stored, by the one or more processor(s), in a centralized database. The centralized database (310) is configured to store the validated drive test data along with a network performance Key Performance Indicator (KPI) and a unique data source identifier. The centralized database (310) is configured to store the validated drive test data in a single column for network performance KPIs such as RSRP/SINR/Throughput, alongside a unique data source identifier for each entry. The centralized database (310) is configured to store the validated drive test data along with the location and time data in a single column. The reports generated by the report generation engine are stored in a manner that is location-specific and based on the drive test round. The centralized database (310) is configured to store the report generated by the report generation engine according to the location (area specific) and according to the drive test round (reports generated per drive test round) (as shown in FIG. 4G). This feature allows for a detailed analysis of the data, which can help in identifying any issues or concerns that need to be addressed.

At step (612), the stored drive test data is visualized, by the one or more processor(s), using a user interface module. The user interface module is capable of layering data from different sources and allowing end-users to view combined or individual data sources selectively.

In another embodiment, the present disclosure discloses a user equipment configured to analyze and visualize drive test data. The user equipment includes a processor and a computer-readable storage medium storing programming instructions for execution by the processor. The programming instructions to receive a plurality of drive test data from a plurality of data sources, each source is configured to have a plurality of key performance indicators (KPIs) information. The processor is configured to parse the received drive test data to extract KPI information corresponding to each KPI and generate parsed drive test data. The processor is configured to translate the parsed drive test data to generate a translated drive test data having a uniform format. The processor is configured to validate the translated drive test data based on a plurality of attributes to generate a validated drive test data. The processor is configured to store the validated drive test data. The processor is configured to visualize the stored drive test data.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method that reduces development efforts involved in incorporating new drive test data sources into the visualization layer. This is achieved by utilizing separate data parser, translator, and validator modules for each data source, eliminating the need for extensive custom development work whenever a new data source is added.

The present disclosure provides a system and a method that ensures seamless scalability by efficiently handling new drive test data sources, and the system achieves this by utilizing a common database to store validated data (validated drive test data) from each source.

The present disclosure provides a system and a method that empower engineers to focus on the most relevant data for their analysis, thereby enhancing efficiency and decision-making capabilities.

The present disclosure provides a system and a method that enables prompt identification and resolution of network issues while optimizing network performance, and engineers can gain real-time insights and proactively take measures to enhance coverage, quality, and interference management.

The present disclosure provides a system and a method that simplifies data analysis and comparison across different data sources, and this facilitates the identification of variations, patterns, and trends, enabling engineers to make more accurate assessments and develop targeted optimization strategies.

1. A method of analyzing and visualizing a drive test data received from a plurality of data sources, the method comprising:
receiving, by one or more processors, a plurality of drive test data from the plurality of data sources, each data source of the plurality of data sources includes a plurality of key performance indicators (KPIs) information;
parsing, by one or more dedicated data parser modules, the received plurality of drive test data to extract the KPI information corresponding to each data source of the plurality of data sources and generating a parsed drive test data;
translating, by one or more dedicated translator modules, the parsed drive test data for generating a translated drive test data having a uniform format;
validating, by one or more dedicated validator modules, the translated drive test data based on a plurality of attributes to generate a validated drive test data;
storing, in a centralized database, the validated drive test data; and
generating visualizations, by a user interface module, of the stored drive test data.

2. The method of claim 1, further comprising providing, by the user interface module, visualization options to end-user to select and visualize drive test data corresponding to each data source of the plurality of data sources.

3. The method of claim 1, further comprising generating a plurality of reports by employing at least one optimization decision technique by leveraging the plurality of KPIs from the plurality of data sources.

4. The method of claim 1, further comprising displaying a layering data combined from different data sources, allowing the end-user to select a view of drive test data by combining two or more data sources.

5. The method of claim 1, wherein the plurality of attributes includes an accuracy attribute, a consistency attribute, a range attribute, and a completeness attribute.

6. The method of claim 1, further comprising storing the validated drive test data, in the centralized database, along with a network performance Key Performance Indicator (KPI) and a unique data source identifier.

7. The method of claim 1, wherein the plurality of KPIs includes a reference signal received power (RSRP), a signal to noise interference ratio (SINR), a reference signal received quality (RSRQ), an uplink throughput, and a downlink throughput.

8. The method of claim 1, further comprising updating the centralized database, when a new data source is incorporated, ensuring seamless access and visualization of an updated drive test data.

9. A system for analyzing and visualizing drive test data received from a plurality of data sources, comprising:
one or more processors configured to receive a plurality of drive test data from the plurality of data sources, each data source of the plurality of data sources is configured to have a plurality of key performance indicators (KPIs) information;
one or more dedicated data parser modules for each individual data source, configured to parse the received plurality of drive test data to extract KPI information corresponding to each data source of the plurality of data sources for generating a parsed drive test data;
one or more dedicated translator modules for each data source of the plurality of data sources, configured to translate the parsed drive test data to generate a translated drive test data having a uniform format;
one or more dedicated validator modules for each data source of the plurality of data sources, configured to validate the translated drive test data based on a plurality of attributes to generate a validated drive test data;
a centralized database configured to store the validated drive test data; and
a user interface module configured to generate a visualization of the stored drive test data.

10. The system of claim 9, wherein the user interface module (311) is configured to provide visualization options to end-user to select and visualize drive test data corresponding to each data source of the plurality of data sources.

11. The system of claim 9, wherein the user interface module is configured to display a layering data combined from different data sources, allowing the end-user to select a view of drive test data by combining two or more data sources.

12. The system of claim 9, wherein the plurality of attributes includes an accuracy attribute, a consistency attribute, a range attribute, and a completeness attribute.

13. The system of claim 9, wherein the centralized database is configured to store the validated drive test data along with a network performance Key Performance Indicator (KPI) and a unique data source identifier.

14. The system of claim 9, wherein the plurality of KPIs includes a reference signal received power (RSRP), a signal to noise interference ratio (SINR), a reference signal received quality (RSRQ), an uplink throughput, and a downlink throughput.

15. The system of claim 9, is further configured to generate a plurality of reports by employing at least one optimization decision technique by leveraging the plurality of KPIs from the plurality of data sources.

16. The system of claim 9, is further configured to update the centralized database, when a new data source is incorporated, ensuring seamless access and visualization of the updated drive test data.

17. (canceled)

18. A computer program product comprising a non-transitory computer-readable medium comprising instructions that, when executed by one or more processors, cause the one or more processors to:
receive a plurality of drive test data from a plurality of data sources, each data source is configured to have a plurality of key performance indicators (KPIs) information;
parse the received plurality of drive test data to extract KPI information corresponding to each data source of the plurality of data sources for generating a parsed drive test data:
translate the parsed drive test data to generate a translated drive test data having a uniform format;
validate the translated drive test data based on a plurality of attributes to generate a validated drive test data:
store the validated drive test data; and
generate a visualization of the stored drive test data.
